(19) United States
(12) Patent Application Publication
(10) Pub. No.: US 2011/0184541 A1
(43) Pub. Date: Jul. 28, 2011

(54) Plug-and-Play audio device

(76) Inventors: Cheng-Hung HUANG, Banqiao City (TW); Cheng-Chieh Huang, Banqiao City (TW); Chien-Chu Chan, Banqiao City (TW)

(21) Appl. No.: 12/777,823

(22) Filed: May 11, 2010

(30) Foreign Application Priority Data
Jan. 22, 2010 (TW) 099201419

(51) Int. Cl. G06F 17/00

(52) U.S. Cl. 700/94

(57) ABSTRACT

The present invention discloses a plug-and-play audio device which can electrically connect to a computer communication interface of a computer device. The plug-and-play audio device comprises a communication interface control unit, a isochronous transfer node unit, an audio control unit, a micro-control unit, a bulk data transfer node unit, a bidirectional data transfer interface unit, a data reading unit, and a data storage unit. The isochronous transfer node unit electrically connects to the communication interface control unit and the audio control unit. The bidirectional data transfer interface unit electrically connects to the micro-control unit and the bulk data transfer node unit, and further comprises a transmission interface to connect an external device. The data reading unit electrically connects to the bulk data transfer node unit. The data storage unit comprises storage modules, driver storage modules and audio device drivers.

### BACKGROUND OF THE INVENTION

1. Field of the Invention

The present invention relates to an audio device, especially to a plug-and-play audio device that combines an audio input module and an audio output module and can automatically execute an audio device driver.

2. Description of the Prior Art

In the present commercially available electronic consumer products, USB interfaces are most popular standard equipments. Every company is developing its own multi-functional electronic consumer products to provide more functions and a more convenience to users. However, many of the additional functions of the electronic consumer products may not operate with the operating system directly, for they do not have standard specifications and therefore can not be driven correctly by the operating system. It is necessary to install the driver in the optical disk provided along with the product to make the product function normally. In other words, users have to use an optical disk drive in connection with the computer in which the product will operate to read the driver program and to install the driver program in the computer. It is not convenient to install the driver in such way that has the following drawbacks about the installation of the product.

First, few users would carry the optical disk along with the product. The optical disc is not designed as a “portable” device. Without the optical disc, the USB product is not as portable as it is designed to be, since it can not be “plugged-and-played” in a computer in which the driver of the USB product is not installed in advance.

Second, after the driver program is installed in one computer, the optical disc becomes useless and would be put away carelessly. When the user needs to install the driver in another computer, it would be very difficult to allocate the optical disc.

Third, in the installation of the driver the driver program is copied into the hard disc drive of the computer and will reside in the operating system program of the computer. It does not unnecessarily occupy the system resources but will also be enacted whenever the computer is restarted, causing the starting time of the computer unnecessarily long.

Forth, the small-sized notebook computers (i.e. Netbook) are getting popular in the recent years. For the requirement of miniaturization, many of the small-sized notebook computers are not equipped with optical drivers. Therefore, users have to use an external optical driver to install the driver of the electronic product, which cause much inconvenience.

The currently commercially available audio devices are the products of single function, such as USB speaker, USB microphone, or USB telephone. If users need more than one functions, he or she have to use more than one of these single-functioned audio devices at the same time. Therefore, in addition to the above-mentioned drawbacks about the installation, each audio device needs to occupy one USB interface of the computer. As a result, the USB slots are usually not sufficient and the power consumption is usually high. In addition, the manufacturing costs are also increased.

It is thus necessary to provide a novel audio that, instead of using a USB HUB, has an integrated multifunction so that users can enjoy its convenience and the manufacturing cost is reduced.

### SUMMARY OF THE INVENTION

In order to improve the aforementioned shortcomings, the present invention provides a plug-and-play audio device which can electrically connect to a computer communication interface of a computer device to receive data from the computer device and transfer data to the computer device. The plug-and-play audio device comprises:

a communication interface control unit which communicates with the computer device through the electrical connection between the communication interface control unit and the computer communication interface;

a isochronous transfer node unit which electrically connects to the communication interface control unit;

an audio control unit which electrically connects to the isochronous transfer node unit, the audio control unit comprising an audio output module and an audio input module, the audio output module receive data from the isochronous transfer node unit and the audio input module transfer data to the isochronous transfer node unit;

a micro-control unit which electrically connects to the communication interface control unit;

a bulk data transfer node unit which electrically connects to the communication interface control unit to transfer a bulk data;

a bidirectional data transfer interface unit which electrically connects to the micro-control unit as well as the bulk data transfer node unit, the bidirectional data transfer interface comprising at least a transmission interface which can connects to an external device and the micro-control unit controlling the external device through the transmission interface;

a data reading unit which electrically connects to the bulk data transfer node unit; and

a data storage unit which electrically connects to the data reading unit, the data storage unit comprising a plurality of storage module which comprises driver storage modules, an audio device driver being stored in the driver storage module.

Therefore, a primary object of the invention is to provide a plug-and-play audio device, wherein the audio output module and the audio input module are integrated in the audio control unit. Through the electrical connection with the isochronous transfer node unit, the audio output module can receive data from the isochronous transfer node unit, and the audio input module can transfer data to the isochronous transfer node unit.

Another object of the present invention is to provide a plug-and-play audio device, wherein the micro-control unit electrically connects to the communication interface control unit, the bulk data transfer node unit, and the bidirectional data transfer interface unit at the same time. Accordingly, the micro-control unit can control the peripheral interface application functions of the communication interface control unit to process the communications of data and to transmit information to the computer device.

Another object of the present invention is to provide a plug-and-play audio device, wherein the data reading unit electrically connects to the bulk data transfer node unit and the data storage unit. Accordingly, the data reading unit can access data of the external device through the bulk data transfer node unit and store the data in the data storage unit.

Still another object of the present invention is to provide a plug-and-play audio device, wherein the data storage device further comprises a plurality of storage modules. The storage modules include a driver storage module that an audio device driver is stored therein. Accordingly, the data reading unit reads a proper audio device driver and this proper audio device driver is uploaded to the computer device. The audio device may then operable and is really “plug-and-play”, instead of using an optical disk to execute the driver program.

Still another object of the present invention is to provide a plug-and-play audio device wherein through the communication interface control unit, the micro-control unit automatically identifies the operating system used by the computer device. According to the kind of the operating system, the data reading unit can automatically change or optionally change the driver and then the driver is uploaded to the computer device and executed automatically. Thereby, the driver programs of peripheral devices are not required to reside in the system of the computer device. No necessary burdens are added to the computer and the power consumption of the computer is reduced.

Still another object of the present invention is to provide a plug-and-play audio device, wherein the storage modules further include an application program storage module. When read by the data reading unit from the external device or the computer device, the application program can be saved into the application program storage module.

Still another object of the present invention is to provide a plug-and-play audio device, wherein the storage modules further include an IP address storage module. When the data reading unit reads an IP address from the IP address storage module, the plug-and-play audio device can transfer the IP address to the computer device through the communication interface control unit. Thereby, the plug-and-play audio device can function as a network radio.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a block diagram of a plug-and-play audio device according to the preferred embodiment of the present invention.

### DESCRIPTION OF THE PREFERRED EMBODIMENT

A detailed description of the present invention will be given below with reference to preferred embodiments thereof, so that a person skilled in the art can readily understand features and functions of the present invention after reviewing the contents disclosed herein.

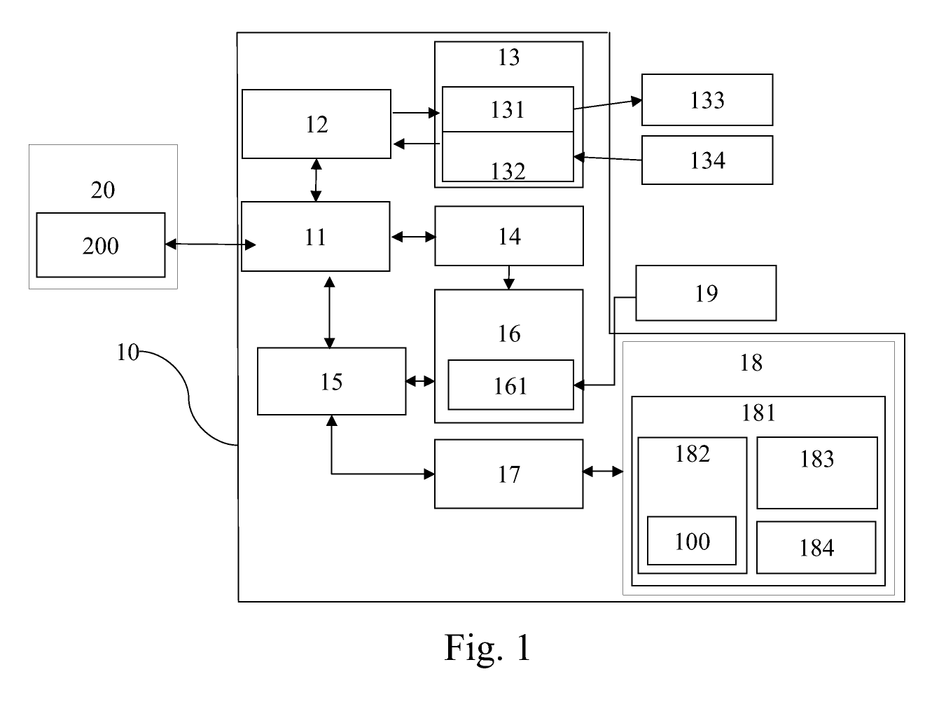

Please refer to FIG. 1, which is a block diagram of the preferred embodiment of the present invention. The plug-and-play audio device 10 can electrically connect to the computer communication interface 200 of the computer device 20. Thereby, the plug-and-play audio device 10 can receive the data from the computer device 20 and transfer the data to the computer device 20.

The plug-and-play audio device 10 comprises a communication interface control unit 11, a isochronous transfer node unit 12, an audio control unit 13, a micro-control unit 14, a bulk data transfer node unit 15, a bidirectional data transfer interface unit 16, a data reading unit 17, and a data storage unit 18.

The communication interface control unit 11 electrically connects to the computer communication interface 200 and communicates with the computer device 20 through the electrical connection between the computer communication interface 200 and the communication interface control unit 11. The isochronous transfer node unit 12 electrically connects to the communication interface control unit 11. Through the electrical connection between the communication interface control unit 11 of the plug-and-play audio device 10 and the computer communication interface 200 of the computer device 20, the isochronous transfer node unit 12 of the plug-and-play audio device can acquires the data of the computer device 20, and plug-and-play audio device 100 can also transfer its data to the computer device 20 via the isochronous transfer node unit 12. The computer communication interface 200 is preferable an USB interface.

The audio control unit 13 electrically connects to the isochronous transfer node unit 12. The audio control unit 13 comprises an audio output module 131 and an audio input module 132. Therefore, the audio input module 131 can receive from the isochronous transfer node unit 12 the data that is previously acquired from the computer device 20. The audio output module 132 can transfer a data to the isochronous transfer node unit 12 and the data is then transferred to the computer device 20 through the isochronous transfer node unit 12.

In addition, the audio output module 131 can further comprise a speaker device 133 which electrically connects to the audio output module 131. Accordingly, the audio output module 131 can output the data that is acquired from the computer device 20 and through the isochronous transfer node unit 12 to the speaker device 133.

The audio input module 132 can further comprise a microphone device 134 which electrically connects to the audio input device module 132. Accordingly, the audio input device 132 can input the data of microphone device 134 into computer device 20 via the isochronous transfer node unit 12.

The micro-control unit 14 electrically connects to the communication interface control unit 11. Therefore, the micro-control unit 14 can control the peripheral interface application functions of the communication interface control unit 11 to process the communications of data and to transmit information. That is, the micro-control unit 14 processes the data transferred from the communication interface control unit 11, carried out any necessary computing, and output the data to the external output interface.

In addition, the bulk data transfer node unit 15 electrically connects to the communication interface control unit 11 to transmit a bulk data.

The micro-control unit 14 may be any commercially available microcontroller or microprocessor. For those who are skilled in the art, it is possible for them to design a micro-control unit 14 to satisfy their requirement as well as to use the core of the microcontroller or the microprocessor designed by others by obtaining the license of the designers.

In addition, the bidirectional data transfer interface unit 16 electrically connects to the micro-control unit 14 as well as the bulk data transfer node unit 15 at the same time. The bidirectional data transfer interface unit 16 at least comprises a transmission interface 161 which may include, but not limited in, a GIPO (graphical interface for planning with objects) interface, a SPI (serial peripheral interface) interface, a Card Reader interface or a UART (universal asynchronous receiver/transmitter) interface. Moreover, for a consumer product which does not use any of the normal standard interface devices, the bulk data transfer node unit 15 may provides a higher data transmission rate than that of the ordinary data transfer node unit.

In addition, the transmission interface 161 may further connects to an external device 19. Therefore, the micro-control unit 14 may control the external device 19 through the transmission interface 161 of the bidirectional data transfer interface unit 16. And the external device 19 may be any electric device, such as a keyboard or a mouse.

The data reading unit 17 electrically connects to the bulk data transfer node unit 15 and the data storage unit 18. Through the bulk data transfer node unit 15, the data reading device 17 may read the data of the external device 19 that is acquired by the bidirectional data transfer interface unit 16 through the transmission 161. And the data is stored in the data storage unit 18 after the data-reading of the data reading unit 17 is complete.

On the other hand, the data reading unit 17 may also read the information acquired from the computer device 200 after the communication interface control unit 11 electrically connects to the computer communication interface 20 of the computer device 20. And the data read therefrom is also stored in the data storage unit 18. The data storage unit 18 comprises a plurality of storage modules 181. Those storage modules may include a driver storage module 182 that stores an audio device driver 100. Accordingly, after the plug-and-play audio device 10 electrically connects to the computer device 20, the proper audio device driver 100 is read through the data storage unit 17 and is uploaded to the computer device 20 to drive the plug-and-play audio device 10 so that the audio device 10 is really plug-and-play and it is not necessary to use any compact disks to execute the driver.

The storage module 181 may include, but is not limited in, an OTP ROM, a Flash ROM, a MASK ROM, or an external NOR flash memory and NAND flash memory.

In addition, the storage modules 181 may also include an application program storage module 183. When the data reading unit 17 reads an application program from the application program storage module 183, the application program is uploaded to the computer device 20 to be used by an user.

The storage modules 181 may still also include an IP address storage module 184. When the data reading unit 17 reads an IP address from the IP address storage module 184, the plug-and-play audio device 10 can access the Internet through the computer device 20. Thereby, the plug-and-play audio device 10 can function as a network radio.

In addition, through the communication interface control unit 11, the micro-control unit 14 automatically identifies the operating system used by the computer device 20. According to the kind of the operating system, the data reading unit 17 can automatically changes or optionally changes the driver, and the audio device driver program stored in the driver storage module 182 may provide a appropriate driver suitable for the audio device 10. Then provided driver is executed automatically. Thus, the driver storage module 182 is not necessarily installed or stays permanently in the system of the computer device 20. Users can directly execute the audio device driver 100 provided by the driver storage module 182 of the pug-and-play audio device 10. No necessary burdens are added to the computer and the power consumption of the computer is reduced.

The preferred embodiment of the present invention is different from the ordinary USB audio device, such as the USB speaker, USB microphone, or USB telephone, that needs its own USB interface to work with the computer device 20. The plug-and-play audio device 10 according to the present invention can integrate the functions of many other audio devices in a single device and users can use this audio device with only one USB interface. The power consumption of the computer is therefore reduced by the reduction of the USB linkage and the reading of the computer.

The present invention can also be implemented by or applied in other embodiments, where changes and modifications can be made to the disclosed details from a viewpoint different from that adopted in this specification without departing from the spirit of the present invention.

What is claimed is:

1. A plug-and-play audio device which can electrically connect to a computer communication interface of a computer device to receive data from the computer device and transfer data to the computer device, the plug-and-play audio device comprises:
a communication interface control unit which communicates with the computer device through the electrical connection between the communication interface control unit and the computer communication interface,
a isochronous transfer node unit which electrically connects to the communication interface control unit,
an audio control unit which electrically connects to the isochronous transfer node unit, the audio control unit comprising an audio output module and an audio input module, the audio output module receive data from the isochronous transfer node unit and the audio input module transfer data to the isochronous transfer node unit,
a micro-control unit which electrically connects to the communication interface control unit,
a bulk data transfer node unit which electrically connects to the communication interface control unit to transfer a bulk data,
a bidirectional data transfer interface unit which electrically connects to the micro-control unit as well as the bulk data transfer node unit, the bidirectional data transfer interface comprising at least a transmission interface which can connects to an external device and the micro-control unit controlling the external device through the transmission interface,
a data reading unit which electrically connects to the bulk data transfer node unit, and
a data storage unit which electrically connects to the data reading unit, the data storage unit comprising a plurality of storage module which comprises driver storage modules stored with an audio device driver.

2. The plug-and-play audio device according to claim 1, wherein the computer communication interface is an USB interface.

3. The plug-and-play audio device according to claim 1, wherein the micro-control unit is a microprocessor.

4. The plug-and-play audio device according to claim 1, wherein the driver storage module is an OTP ROM.

5. The plug-and-play audio device according to claim 1, wherein the driver storage module is a MASK ROM.

6. The plug-and-play audio device according to claim 1, wherein the driver storage module is a Flash ROM.

7. The plug-and-play audio device according to claim 1, wherein the driver storage module is an external NOR Flash memory.

8. The plug-and-play audio device according to claim 1, wherein the driver storage module is a NAND flash memory.

9. The plug-and-play audio device according to claim 1, wherein the transmission interface is a GIPO interface.

10. The plug-and-play audio device according to claim 1, wherein the transmission interface is a SPI interface.

11. The plug-and-play audio device according to claim 1, wherein the transmission interface is a Card Reader interface.

12. The plug-and-play audio device according to claim 1, wherein the transmission interface is a UART interface.

13. The plug-and-play audio device according to claim 1 further comprising a speaker device which electrically connects to the audio output module.

14. The plug-and-play audio device according to claim 1 further comprising a microphone device which electrically connects to the audio input module.

15. The plug-and-play audio device according to claim 1, wherein the external device is a keyboard.

16. The plug-and-play audio device according to claim 1, wherein the external device is a mouse.

17. The plug-and-play audio device according to claim 1, wherein the plurality of storage modules further comprise an application program storage module which stores at least an application program.

18. The plug-and-play audio device according to claim 1, wherein the plurality of storage modules further comprise an IP address storage module which stores at least an IP address.
